(19) United States
(12) Patent Application Publication
(10) Pub. No.: US 2026/0169129 A1
(43) Pub. Date: Jun. 18, 2026

(54) OPTICAL RANGING SENSOR WITH THREE-HUNDRED AND SIXTY DEGREE FIELD-OF-VIEW

(71) Applicant: STMicroelectronics International N.V., Geneva (CH)

(72) Inventors: Thomas PEROTTO, Grenoble (FR); Charlotte MILANETTO, Grenoble (FR)

(21) Appl. No.: 18/978,815

(22) Filed: Dec. 12, 2024

(51) Int. Cl. G01S 7/481; G01S 7/4865; G01S 17/04; G01S 17/89

(52) U.S. Cl. CPC G01S 7/4811; G01S 7/4866; G01S 17/04; G01S 17/89

(57) ABSTRACT

An example optical ranging sensor system, and a method for detecting the presence of a target object are provided. The example optical ranging sensor system include an optical transmitter, and optical receiver, and a convex reflective surface. The optical transmitter is configured to transmit an optical signal in a transmission field-of-view. The optical receiver is configured to receive a returning optical signal reflected off a target object in a return field-of-view. The convex reflective surface being positioned within the transmission field-of-view and the return field-of-view, such that the transmitted optical signal is reflected off the convex reflective surface toward the target object in a detection field-of-view.

### TECHNOLOGICAL FIELD

Embodiments of the present disclosure relate generally to optical ranging sensors, and more particularly, to optical ranging sensors configured to detect objects at an increased field-of-view.

### BACKGROUND

Many devices utilize optical ranging sensors to determine the presence, location, and motion of objects in a surrounding environment based on returned light reflected from target objects. For example, robotic devices, smart speakers, motion detect lights and cameras, household appliances, and so on may all utilize optical ranging sensors to detect presence, proximity, motion, and/or distance of surrounding objects nearby the device. More and more, optical ranging sensors are requiring a larger field-of-view.

Applicant has identified many technical challenges and difficulties associated with increasing the field-of-view of an optical ranging sensor. Through applied effort, ingenuity, and innovation, Applicant has solved problems related to increasing the field-of-view of an optical ranging sensor by developing solutions embodied in the present disclosure, which are described in detail below.

### BRIEF SUMMARY

Various embodiments are directed to an example optical ranging sensor system, and a method for detecting presence of a target object. The example optical ranging sensor system comprises an optical transmitter, and optical receiver, and a convex reflective surface. The optical transmitter having a transmission field-of-view, configured to transmit a transmitted optical signal. The optical receiver having a return field-of-view and configured to receive a returning optical signal reflected off a target object. The convex reflective surface positioned within the transmission field-of-view and the return field-of-view. The transmitted optical signal is reflected off the convex reflective surface toward the target object in a detection field-of-view.

In some embodiments, the transmitted optical signal is transmitted along a transmission axis, and the detection field-of-view is perpendicular to the transmission axis.

In some embodiments, the convex reflective surface is stationary.

In some embodiments, the detection field-of-view is 360 degrees.

In some embodiments, the convex reflective surface is positioned at a minimum overlap distance from an intersection line, wherein the intersection line intersects the optical transmitter and the optical receiver.

In some embodiments, the minimum overlap distance is determined based on a separation distance between the optical transmitter and the optical receiver, the transmission field-of-view, and the return field-of-view.

In some embodiments, a top portion of the convex reflective surface is at the minimum overlap distance relative to the intersection line.

In some embodiments, the convex reflective surface is centered between the optical transmitter and the optical receiver.

In some embodiments, the optical ranging sensor system further comprises a housing configured to fix a position of the convex reflective surface relative to the optical transmitter and the optical receiver.

In some embodiments, the housing further comprises a sensor compartment, a bottom portion, and a side wall. The sensor compartment defining a sensor cavity, wherein the optical transmitter and the optical receiver are disposed within the sensor cavity. The convex reflective surface is attached to the bottom portion. The side wall attaching the bottom portion to the sensor compartment.

In some embodiments, a portion of the side wall is optically transparent, such that the transmitted optical signal passes through the side wall.

In some embodiments, the side wall is circular.

In some embodiments, the transmitted optical signal is pulsed for an optical pulse width, wherein the optical pulse width is less than 0.6 nanoseconds.

In some embodiments, the optical ranging sensor system further comprises a controller configured to: transmit the transmitted optical signal toward the convex reflective surface; receive the returning optical signal reflected off the target object; determine a depth histogram based on the returning optical signal; and determine a presence of the target object based on the depth histogram.

A method for detecting a presence of a target object is further provided. In some embodiments, the method comprises providing an optical ranging sensor system. The optical ranging sensor system includes an optical transmitter, an optical receiver, and a convex reflective surface. The optical transmitter having a transmission field-of-view, configured to transmit a transmitted optical signal; an optical receiver having a return field-of-view and configured to receive a returning optical signal reflected off the target object; and a convex reflective surface positioned within the transmission field-of-view and the return field-of-view. The transmitted optical signal is reflected off the convex reflective surface toward the target object in a detection field-of-view. The method further comprising: transmitting the transmitted optical signal toward the convex reflective surface; receiving the returning optical signal reflected off the target object; determining a depth histogram based on the returning optical signal; and determining the presence of the target object based on the depth histogram.

In some embodiments, the method further comprises removing one or more bins of the depth histogram representing returning optical signal reflected within a minimum depth detection distance.

In some embodiments, the convex reflective surface is stationary.

In some embodiments, the detection field-of-view is 360 degrees.

In some embodiments, the convex reflective surface is positioned at a minimum overlap distance from an intersection line, wherein the intersection line intersects the optical transmitter and the optical receiver, and wherein the minimum overlap distance is determined based on a separation distance between the optical transmitter and the optical receiver, the transmission field-of-view and the return field-of-view.

In some embodiments, the convex reflective surface is centered between the optical transmitter and the optical receiver.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates an example block diagram of an example optical ranging sensor in a three-dimensional scene.

FIG. 2 illustrates an example optical ranging sensor system comprising a convex reflective surface in accordance with an example embodiment of the present disclosure.

FIG. 3 illustrates a transmitted optical signal reflected off a convex reflective surface to create a 360-degree detection field-of-view in accordance with an example embodiment of the present disclosure.

FIG. 4 illustrates an example transmission field-of-view and return field-of-view of an optical ranging sensor in accordance with an example embodiment of the present disclosure.

FIG. 5 illustrates an example equation for determining a minimum overlap distance of a transmission field-of-view and return field-of-view in accordance with an example embodiment of the present disclosure.

FIG. 6A-FIG. 6B depict an example detection field-of-view in accordance with an example embodiment of the present disclosure.

FIG. 7 depicts an example shortened optical pulse width for a pulse transmitted optical signal in accordance with an example embodiment of the present disclosure.

FIG. 8 depicts an example depth histogram generated by a controller of an optical ranging sensor system in accordance with an example embodiment of the present disclosure.

FIG. 9 depicts an example flow diagram illustrating an example method for detecting a presence of a target object in accordance with an example embodiment of the present disclosure.

FIG. 10 depicts an example block diagram of components of a controller in accordance with an example embodiment of the present disclosure.

### DETAILED DESCRIPTION

Example embodiments will be described more fully hereinafter with reference to the accompanying drawings, in which some, but not all embodiments of the inventions of the disclosure are shown. Indeed, embodiments of the disclosure may be embodied in many different forms and should not be construed as limited to the embodiments set forth herein; rather, these embodiments are provided so that this disclosure will satisfy applicable legal requirements. Like numbers refer to like elements throughout.

Various example embodiments address technical problems associated with increasing the detection field-of-view of an optical ranging sensor in an optical ranging sensor system. As understood by those of skill in the field to which the present disclosure pertains, there are numerous example scenarios in which a system may benefit from an optical ranging sensor operating with an increased detection field-of-view.

For example, many devices utilize optical ranging sensors to determine the location and motion of objects in a surrounding environment based on returned light reflected off one or more target objects. Devices include robotic devices (e.g., robotic vacuums, robotic mops, robotic lawn mowers, etc.), smart speakers (e.g., virtual assistant), motion detect lights, motion detect cameras, household appliances, smart thermostats, and so on. Such devices may utilize optical ranging sensors to detect presence, proximity, motion, and/or distance of surrounding objects nearby the device. The devices may perform an action based on the detected presence of a target object. For example, a robotic device may avoid a detected object, a smart speaker or virtual assistant may communicate based on the presence of a detected object, a motion detect light may turn on based on the presence or motion of an object, and so on.

More and more, devices utilizing or potentially utilizing an optical ranging sensor for presence/motion detection require a large field-of-view (e.g., greater than 60 degrees). A large field-of-view may enable detection of objects in a larger portion of the surrounding environment. Indeed, some devices may even prioritize presence/motion detection across a large field-of-view over high accuracy results.

Various previous examples have utilized ultra-wide lenses and/or mechanical methods (e.g., moving parts) to increase the field-of-view. Ultra-wide lenses are limited based on the optical characteristics of the sensor and may experience significant degradation in performance. Mechanical methods may be utilized to direct the transmitted optical signal in various directions. However, mechanical methods require moving parts which require maintenance to maintain. Still, other previous examples may utilize multiple sensors aligned to provide a wider field-of-view coverage. Multiple sensors are expensive, take up more area, and our complex to implement. Thus, a simple, low-cost solution to increase the field-of-view of a time-of-flight sensor is needed.

The various example embodiments described herein utilize various techniques to increase the detection field-of-view of an optical ranging sensor. For example, in one embodiment, a convex reflective surface is positioned within the transmission field-of-view and the return field-of-view of an optical ranging sensor. The convex reflective surface reflects a transmitted optical signal generated by an optical transmitter in a 360-degree plane perpendicular to the transmission axis of the transmitted optical signal. The returning optical signal reflected off one or more target objects in an external environment is directed by the convex reflective surface toward an optical receiver at the optical ranging sensor. By reflecting the transmitted optical signal in a 360-degree plane and directing the returning optical signal to the optical ranging sensor, the convex reflective surface enables a 360-degree detection field-of-view for the optical ranging sensor system.

Further, in some embodiments, the convex reflective surface may be positioned relative to the optical ranging sensor based on a minimum overlap distance. For example, the minimum overlap distance may be determined relative to an intersection line intersecting the optical transmitter and the optical receiver based on the distance between the optical transmitter and the optical receiver, and the respective field-of-views of the optical transmitter (e.g., transmission field-of-view) and the optical receiver (e.g., return field-of-view). In some embodiments, the top portion of the convex reflective surface may be centered between the optical transmitter and the optical receiver at the minimum overlap distance.

As a result of the herein described example embodiments, the detection field-of-view of an optical ranging sensor may be greatly improved. In addition, the improvements to detection field-of-view may be implemented at a low cost, simple implementation, and with minimal maintenance.

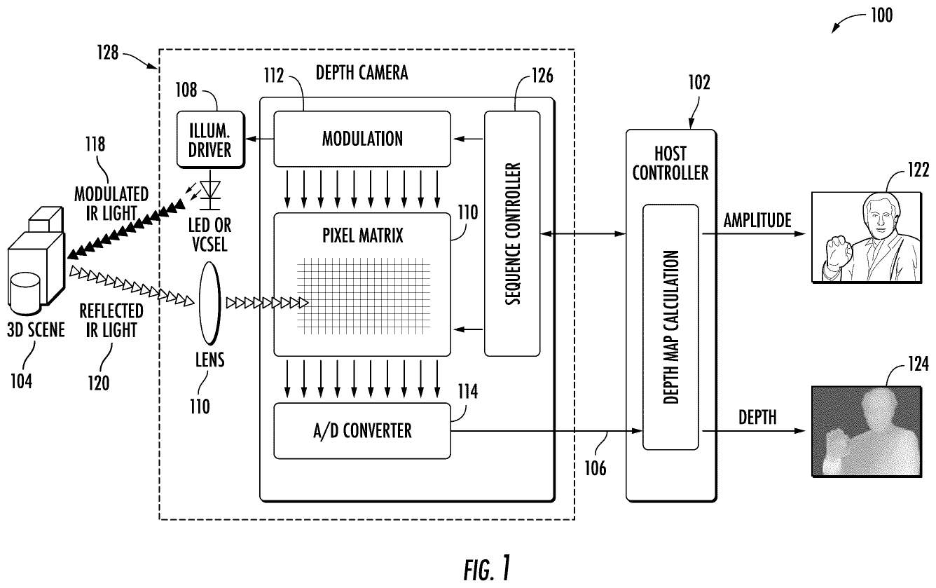

Referring now to FIG. 1, an example optical ranging sensor 100 is provided. As depicted in FIG. 1, the example optical ranging sensor 100 includes a sensor compartment 128 enclosing an optical transmitter 108, and an optical receiver 110. The optical transmitter 108 is configured to generate a transmitted optical signal 118 directed into an external environment. The optical receiver 110 is configured to receive a returning optical signal 120 reflected off a target object 104 and passed through a lens 116. As further depicted in FIG. 1, the example optical ranging sensor 100 includes a controller 102. The controller 102 is configured to coordinate the transmission of the transmitted optical signal 118 with the reception of the returning optical signal 120 through sequence controller circuitry 126. In addition, the controller 102 is configured to received image data 106 from analog-to-digital converter circuitry 114 generated based on the returning optical signal 120 received at the optical receiver 110. The controller 102 may generate an amplitude image 122 and/or depth image 124 based on the received image data 106. In some embodiments, the controller 102 may be co-located with the optical transmitter 108 and the optical receiver 110 within the sensor compartment 128.

As depicted in FIG. 1, the example optical ranging sensor 100 includes an optical transmitter 108. An optical transmitter 108 is any device, bulb, semiconductor, light emitting diode, laser, or other photon-emitting structure configured to generate a transmitted optical signal 118. An optical transmitter 108 may comprise any light source, such as a laser diode, a light-emitting diode, bulb, semiconductor device, or other photon-emitting structure. In some embodiments, an optical transmitter 108 may comprise a semiconductor laser diode, for example, a vertical-cavity surface-emitting laser (VCSEL) and/or an edge emitting laser diode. In general, an optical transmitter 108 may output a coherent light beam upon receipt of a current.

In some embodiments, the optical transmitter 108 may be configured to generate optical pulses having an optical pulse width as the transmitted optical signal 118. Optical pulses are short bursts of light. The optical pulse width corresponds to the amount of time the optical transmitter 108 is illuminated to generate the optical pulse. The transmitted optical signal 118 comprises any electromagnetic signal generated by the optical transmitter 108 and directed to an external environment. The transmitted optical signal 118 may be generated at or filtered to a specific wavelength. For example, the transmitted optical signal 118 may comprise infrared light.

An optical transmitter 108 is associated with a transmission field-of-view. A transmission field-of-view is an angular range within which an optical transmitter 108 may effectively transmit signals. The transmission field-of-view may be defined by the photon-emitting structure. In addition, the transmission field-of-view may be defined by an aperture or other optical structure used to direct the transmitted optical signal 118.

As further depicted in FIG. 1, the example optical ranging sensor 100 includes an optical receiver 110. An optical receiver 110 is any set of one or more photodiodes, integrated circuits, devices, sensors, light sensing diodes, or other photodetector structures that produce an electric signal (e.g., image data 106) as a result of light received at the optical receiver 110. For example, the electric signal output by the optical receiver 110 may increase as the number of photons that strike the optical receiver 110 per second increases. In such an embodiment, the electric current output from the optical receiver 110 may be used to determine the intensity or amplitude of the optical radiation striking the optical receiver 110. In some embodiments, the optical receiver 110 may be a light sensitive semiconductor diode that creates an electron-hole pair at the p-n junction when a photon of sufficient energy strikes the optical receiver 110. In some embodiments, the optical receiver 110 may comprise one or more single-photon avalanche diodes (SPADs) configured to generate an avalanche current when one or more photons strike the optical receiver 110.

As depicted in FIG. 1, the optical receiver 110 comprises a plurality of photodetector structures (e.g., pixels) arranged in a two-dimensional array. In such an embodiment, each pixel corresponds to a real-world location in the external environment. The electrical output from each pixel may correspond to the amount of light received from the corresponding real-world location. In an instance in which the pixel is integrated over a period of time, the electrical output from each pixel may represent the amplitude of light received from the particular real-world location, and the controller 102 may use the received image data 106 to generate an amplitude image 122. In an instance in which the electrical output is accumulated for a specific time period relative to the generation of the transmitted optical signal 118, the controller 102 may generate a depth histogram for each pixel location. A depth histogram may be utilized to generate a depth image 124. As depicted in FIG. 1, the received image data 106 may be generated by an analog-to-digital converter circuitry 114 configured to generate a digital output based on the analog signal generated by a pixel of the optical receiver 110.

Determinations about target objects 104 may be made based on the returning optical signal 120 reflected off one or more target objects, for example, the distance of the target object, the motion of the target object, the speed of the target object, surface properties of the target object, and so on.

An optical receiver 110 is associated with a return field-of-view. A return field-of-view is an angular range which can be seen or detected by the optical receiver 110. The return field-of-view may be defined by the optical receiver 110. In addition, the return field-of-view may be defined by an aperture or other optical structure (e.g., lens 116) used to direct the returning optical signal 120 toward the optical receiver 110.

As further depicted in FIG. 1, the example optical ranging sensor 100 includes a controller 102. The controller 102 utilizes a sequence controller circuitry 126 to synchronize the transmission of the transmitted optical signal 118 and the reception of the returning optical signal 120.

In general, an optical ranging sensor 100 operates by measuring the time it takes for an optical signal (e.g., transmitted optical signal 118), usually emitted as a laser or infrared pulse, to travel to a target object 104 and reflect back to the sensor. The optical ranging sensor 100 calculates the distance to the target object 104 based on the speed of light and the time delay between the emission and detection of the optical signal. The optical ranging sensor 100 of the optical signal may be used to measure a distance to the target object, track the motion of the target object, determine a speed of the target object, detect presence of a target object, determine material properties of a target object, and/or map target objects in an environment with high precision.

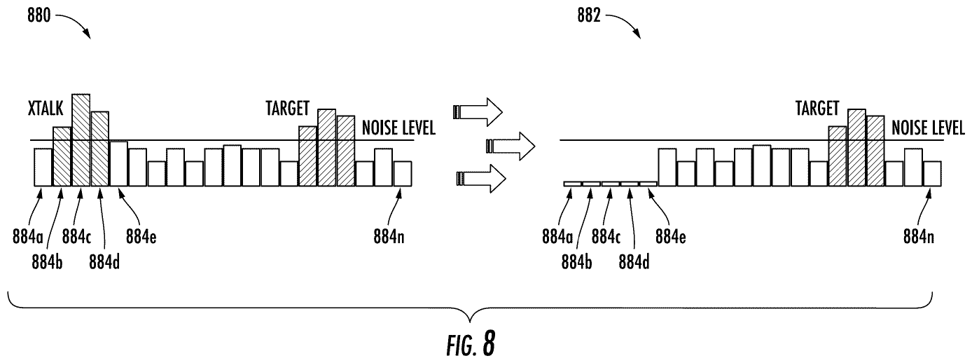

The controller 102 may further be configured to capture the received image data 106 and generate an amplitude image 122 and/or depth image 124. An amplitude image 122 represents the intensity or brightness of the returning optical signal 120 at each pixel location. The amplitude image 122 indicates the intensity or brightness reflected at a particular pixel location. A depth image 124 provides information about the distance of target objects 104 associated with a pixel location. In other words, a depth image 124 indicates the distance to a target object 104 at the corresponding pixel location. A depth image 124 may be determined based on depth histogram. An example depth histogram is described in relation to FIG. 8.

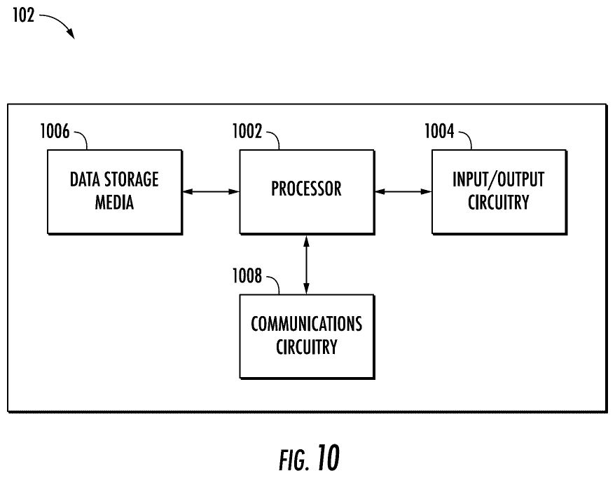

An example block diagram of components of an example controller (e.g., controller 102) is depicted in FIG. 10. Although depicted outside of the sensor compartment 128, in some embodiments, the controller 102 may be contained within the sensor compartment 128.

An optical ranging sensor 100 is further associated with a detection field-of-view. A detection field-of-view is an angular range for which the optical ranging sensor 100 may detect target objects 104. In some previous examples, the detection field-of-view may have been limited based on the transmission field-of-view associated with the optical transmitter 108 and/or the returning field-of-view associated with the optical receiver 110. For example, in an instance in which the transmission field-of-view is 60 degrees, the maximum detection field-of-view was limited to 60 degrees. Similarly, in an instance in which the return field-of-view is 50 degrees, the maximum detection field-of-view was limited to 50 degrees. As a result of the embodiments described herein, the detection field-of-view of an optical ranging sensor 100 may be increased.

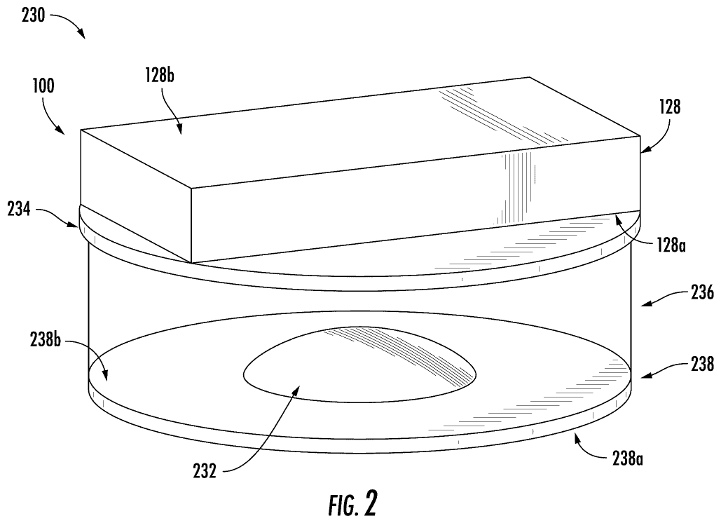

Referring now to FIG. 2, an example optical ranging sensor system 230 is provided. As depicted in FIG. 2, the example optical ranging sensor system 230 includes a housing 234 comprising a sensor compartment 128. The optical ranging sensor 100, including the optical transmitter (e.g., optical transmitter 108), the optical receiver (e.g., optical receiver 110), and the controller (e.g., controller 102) in some embodiments, may be disposed within the sensor cavity defined by the sensor compartment 128.

As depicted in FIG. 2, the sensor compartment 128 comprises a top surface 128b and a bottom surface 128a. Although not depicted in FIG. 2, the bottom surface 128a comprises a first opening or aperture for the optical transmitter and a second opening or aperture for the optical receiver.

As further depicted in FIG. 2, the housing 234 includes a bottom portion 238 attached to the sensor compartment 128 by a side wall 236. The bottom portion 238 comprises a top surface 238b adjacent the bottom surface 128a of the sensor compartment 128 and a bottom surface 238a opposite the sensor compartment 128. A convex reflective surface 232 is attached to the top surface 238b of the bottom portion 238 of the housing 234. Thus, transmitted optical signals 118 transmitted out of the bottom surface 128a of the sensor compartment 128 are directed to the bottom portion 238 of the housing 234 and the convex reflective surface 232 attached to the top surface 238b of the bottom portion 238.

As depicted in FIG. 2, the optical ranging sensor system 230 includes a convex reflective surface 232. The convex reflective surface 232 is any curved surface configured to reflect the transmitted optical signal generated by an optical ranging sensor in a plane or direction perpendicular to a transmission axis of the optical transmitter 108. A convex reflective surface 232 may comprise any reflective material, for example, glass, metal, aluminum foil, silver, stainless steel, plastic, or other reflective material.

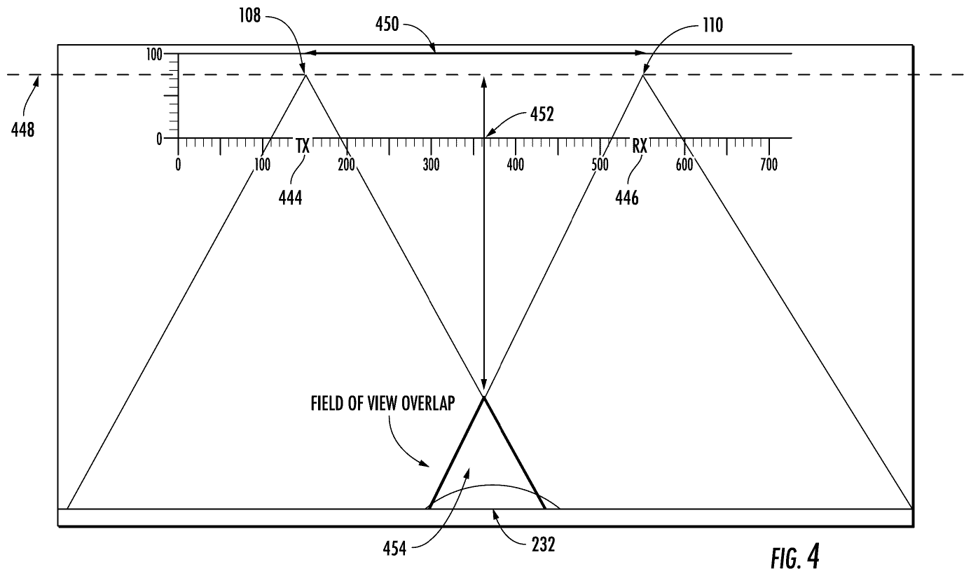

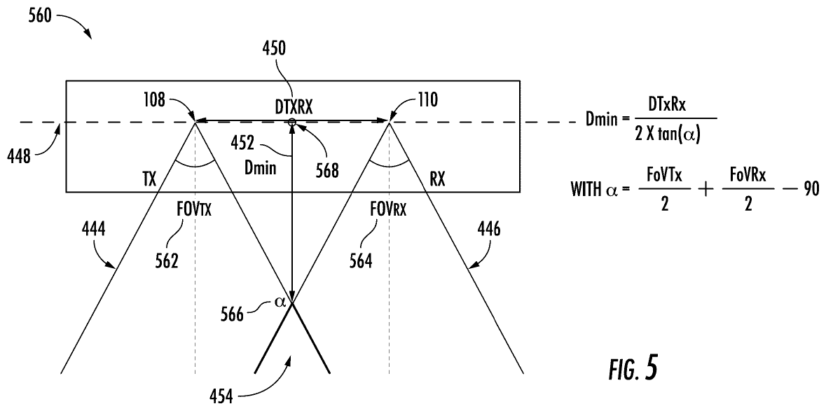

In some embodiments, the convex reflective surface 232 comprises a spherical shape having a fixed radius. In some embodiments, the convex reflective surface 232 comprises a top portion of a spherical shape, for example, a hemisphere. The convex reflective surface 232 is positioned in a stationary position such that it is at least partially within the transmission field-of-view and the return field-of-view. In some embodiments, the spherical shape of the convex reflective surface 232 may be defined by a radius of curvature. For example, the radius of curvature may be less than 2 millimeters. The convex reflective surface 232 is further positioned at least a minimum overlap distance from the optical ranging sensor 100. The position of the convex reflective surface 232 is discussed further in relation to FIG. 4 and FIG. 5.

As further depicted in FIG. 2, the housing 234 includes a side wall 236. The side wall 236 attaches the sensor compartment 128 to the bottom portion 238 of the housing 234. The side wall 236 defines a transmission cavity 240 between the bottom portion 238 of the housing 234 and the sensor compartment 128. The transmission cavity 240, including the side wall 236 is transparent at least to one or more wavelengths of light comprising the transmitted optical signal. Thus, the transmitted optical signal and returning optical signal may pass through the side wall 236 and the transmission cavity 240.

As further depicted in FIG. 2, the convex reflective surface 232 is attached to the bottom portion 238 within the transmission cavity 240. The side wall 236 further defines the distance between the optical ranging sensor 100 and the convex reflective surface 232. Thus, in some embodiments, the side wall 236 may be adjusted based on the minimum overlap distance of the optical ranging sensor 100. As further depicted in FIG. 2, the side wall is circular, forming a 360-degree transparent path out of the optical ranging sensor system 230 perpendicular to the transmission axis of the optical ranging sensor 100.

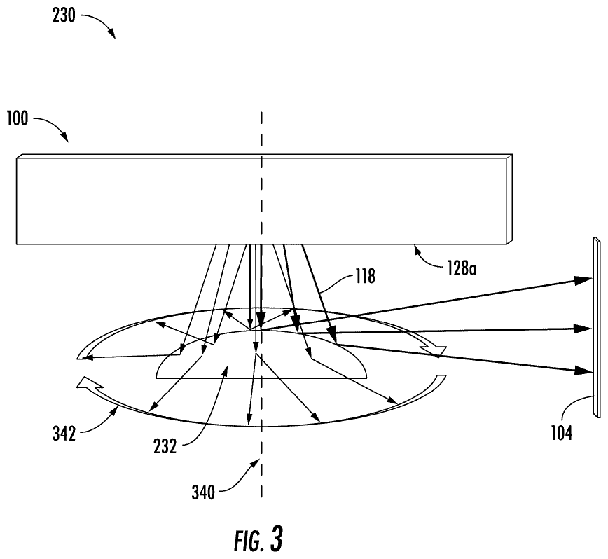

Referring now to FIG. 3, an example optical ranging sensor system 230 depicting a transmitted optical signal 118 reflected in a 360-degree detection field-of-view 342 is depicted. As depicted in FIG. 3, a transmitted optical signal 118 is transmitted out the bottom surface 128a of an optical ranging sensor 100 along a transmission axis 340. As further depicted in FIG. 3, a convex reflective surface 232 is positioned within the transmission field-of-view of an optical transmitter (e.g., optical transmitter 108) within the optical ranging sensor 100 (not shown).

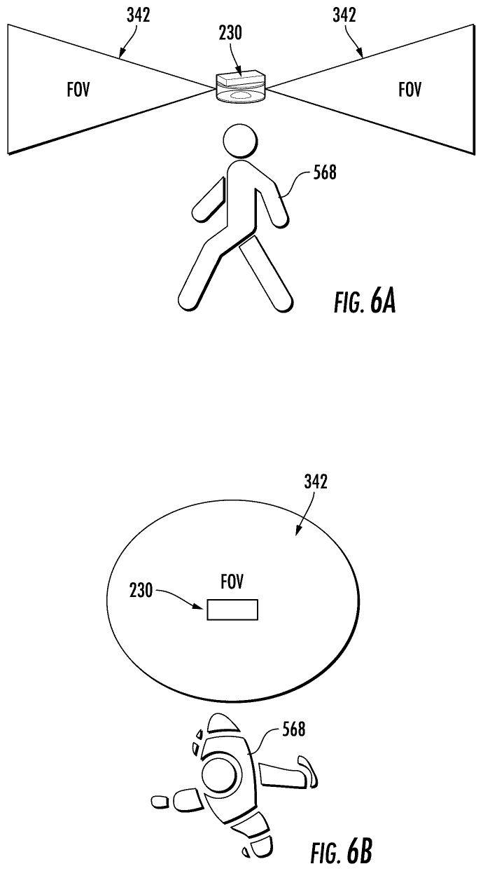

As depicted in FIG. 3, the detection field-of-view 342 is an angular range for which the optical ranging sensor 100 may detect target objects 104. Since the convex reflective surface 232 is positioned within the transmission field-of-view, and since the convex reflective surface 232 is curved, the transmitted optical signal 118 is reflected in all directions (360-degrees) in an angular range about the plane perpendicular to the transmission axis 340. A target object 104 positioned anywhere within the detection field-of-view 342 interacts with the transmitted optical signal 118. Thus, the convex reflective surface 232 enables target objects 104 to be detected in a 360-degree detection field-of-view. An example detection field-of-view 342 is described in relation to FIG. 6A-FIG. 6B.

Referring now to FIG. 4, an example optical ranging sensor system 230 illustrating a transmission field-of-view 444 associated with an optical transmitter 108 and a return field-of-view 446 associated with an optical receiver 110 is depicted.

As depicted in FIG. 4, the optical ranging sensor system 230 includes an optical transmitter 108 and an optical receiver 110. The optical transmitter 108 and the optical receiver 110 are separated by a separation distance 450. In addition, the optical transmitter 108 is associated with a transmission field-of-view 444 having a transmission field-of-view angle. The optical receiver 110 is associated with a return field-of-view 446 having a return field-of-view angle. The transmission field-of-view 444 and the return field-of-view 446 further overlap at a field-of-view overlap region 454.

As further depicted in FIG. 4, an imaginary intersection line 448 intersects both the optical transmitter 108 and the optical receiver 110. A minimum overlap distance 452 representing the distance from the intersection line 448 to the field-of-view overlap region 454 is depicted. The minimum overlap distance 452 may be determined based on the transmission field-of-view angle, the return field-of-view angle, and the separation distance 450. An example determination of a minimum overlap distance 452 is described in relation to FIG. 5.

As further depicted in FIG. 4, the convex reflective surface 232 is centered along the intersection line 448. Thus, the top portion of the convex reflective surface 232 is directly under the center point between the optical transmitter 108 and the optical receiver 110. In addition, the convex reflective surface 232 is positioned at least the minimum overlap distance 452 from the intersection line 448. As depicted in FIG. 4, the convex reflective surface 232 is positioned such that the convex reflective surface 232 is completely within the transmission field-of-view 444 and the return field-of-view 446. In some embodiments, the convex reflective surface 232 is positioned such that the center of the top portion of the convex reflective surface 232 is at the minimum overlap distance 452.

Referring now to FIG. 5, an example determination of a minimum overlap distance 452 on an example optical ranging sensor 560 is provided. As depicted in FIG. 5, the example optical ranging sensor 560 includes an optical transmitter 108 and an optical receiver 110. The optical transmitter 108 and the optical receiver 110 are separated by a separation distance 450. In addition, the optical transmitter 108 is associated with a transmission field-of-view 444 having a transmission field-of-view angle 562. The optical receiver 110 is associated with a return field-of-view 446 having a return field-of-view angle 564. As depicted in FIG. 5, the transmission field-of-view 444 and the return field-of-view 446 further overlap at a field-of-view overlap region 454.

As further depicted in FIG. 5, an intersection line 448 is drawn between the optical transmitter 108 and the optical receiver 110 and intersects both the optical transmitter 108 and the optical receiver 110. A minimum overlap distance 452 representing the distance from the intersection line 448 to the field-of-view overlap region 454 is depicted. In addition, the optical transmitter 108 and optical receiver 110 are separated by a separation distance 450 along the intersection line 448. A center point 568 marks the point along the intersection line 448 halfway between the optical transmitter 108 and the optical receiver 110. The overlap angle 566 (α) is the angle of the intersection of the transmission field-of-view 444 with the return field-of-view 446.

As depicted in FIG. 5, the overlap angle 566 (α) may be determined by Equation (1):

$$α = \frac{FoVTx}{2} + \frac{FoVRx}{2} - 90 \qquad ( 1 )$$

where α is the overlap angle 566, FoVTx is the transmission field-of-view angle 562, and FoVRx is the return field-of-view angle 564.

As further depicted in FIG. 5, the minimum overlap distance 452 may be determined by Equation (2):

$$D min = \frac{DtxRx}{2 \times tan ( α )} \qquad ( 2 )$$

where Dmin is the minimum overlap distance 452, DtxRx is the separation distance 450, and a is the overlap angle 566. In an example in which the FoVTx and the FoVRx are both 45 degrees and the separation distance 450 is 4 millimeters, the overlap angle 566 may be determined by Equation (1):

$$α = \frac{45}{2} + \frac{45}{2} - 90 = 45$$

and, the minimum overlap distance 452 may be determined by Equation (2):

$$D min = \frac{4 millimeters}{2 \times tan ( 45 )} = 2 millimeters \qquad ( 3 )$$

Referring now to FIG. 6A-FIG. 6B, an example detection field-of-view 342 for an example optical ranging sensor system 230 is provided. A detection field-of-view 342 is an angular range for which the optical ranging sensor system 230 may detect target objects 104.

FIG. 6A depicts a side view of an example optical ranging sensor system 230 and corresponding detection field-of-view 342. As depicted in FIG. 6A, the example detection field-of-view 342 extends out the side wall (e.g., side wall 236) of the optical ranging sensor system 230 about a plane perpendicular to the transmission axis (e.g., transmission axis 340) of the optical transmitter of the optical ranging sensor system 230. Thus, as depicted in FIG. 6A, a target object 104 directly below the bottom portion of the optical ranging sensor system 230 housing is not within the detection field-of-view 342 of the optical ranging sensor system 230.

FIG. 6B depicts a top view of an example optical ranging sensor system 230 and corresponding detection field-of-view 342. As depicted in FIG. 6B, the example detection field-of-view 342 extends out the side wall (e.g., side wall 236) of the optical ranging sensor system 230 in all directions (360 degrees). Thus, as depicted in FIG. 6B, any target object 104 in a lateral direction from the optical ranging sensor system 230 is within the detection field-of-view 342 of the optical ranging sensor system 230.

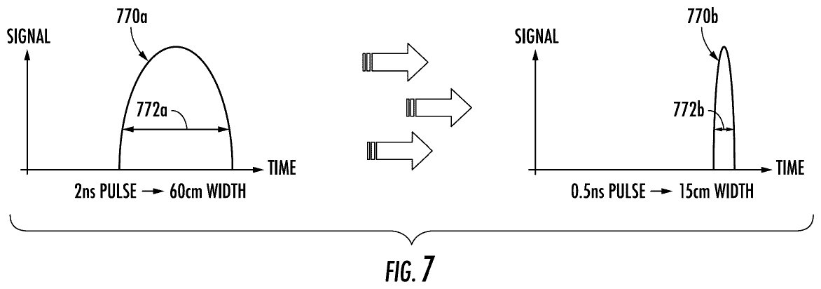

Referring now to FIG. 7, an example optical pulse 770a having an optical pulse width 772a at or around two nanoseconds is depicted. Further, an example optical pulse 770b having an optical pulse width 772b at or around 0.5 nanoseconds is depicted. In general, an optical ranging sensor system (optical ranging sensor system 230) transmits the transmitted optical signal (e.g., transmitted optical signal 118) in optical pulses 770a/770b having an optical pulse width 772a/772b. The optical pulse width 772a/772b may be measured in time (e.g., 0.5 nanoseconds) and/or distance (e.g., 15 centimeters). The optical pulse width 772a/772b determines the resolution of the optical ranging sensor system. For example, an optical pulse 770a/770b having a larger optical pulse width 772a/772b may increase the range and accuracy of the optical ranging sensor system, but with a larger resolution. The optical pulse width 772a/772b may be defined by the optical transmitter. For example, the optical pulse width 772a/772b may be associated with the amount of time for which the optical transmitter 108 is illuminated.

In some embodiments, the convex reflective surface (e.g., convex reflective surface 232) and/or housing (e.g., housing 234) of an optical ranging sensor system may result in crosstalk signals received at the optical receiver (e.g., optical receiver 110). Crosstalk signals correspond to light received from unwanted sources in the optical ranging sensor system. Crosstalk sources may include light that traveled directly from the optical transmitter to the optical receiver, perhaps, via reflections at and through a cover glass or optical component. Crosstalk sources may also include reflections from the convex reflective surface directly to the optical receiver, and/or reflections from the optical ranging sensor system housing (e.g., housing 234), for example, the side wall (e.g., side wall 236) of the optical ranging sensor system housing. The crosstalk portion of the feedback signals may result in inaccuracies when determining physical attributes of s target object.

As depicted in FIG. 7, shortening the optical pulse width (e.g., optical pulse width 772b) may increase the resolution of the optical ranging sensor system. In addition, shortening the optical pulse width 772b may reduce the amount of crosstalk returned to the optical receiver. Reducing the amount of crosstalk may enable the optical ranging sensor system 230 to more easily filter or remove returning optical signals due to crosstalk. In some embodiments, the optical pulse width 772a/772b be less than 1 nanoseconds; more preferably less than 0.75 nanoseconds; most preferably less than 0.6 nanoseconds.

Referring now to FIG. 8, an example depth histogram 880 and an example modified depth histogram 882, modified to remove the affects of crosstalk, are depicted.

During operation, an optical transmitter (e.g., optical transmitter 108) may transmit an optical pulse into an external environment. An optical receiver (e.g., optical receiver 110) may collect data related to the returning optical signal (e.g., returning optical signal 120) received at the optical receiver based on the elapsed time since the optical pulse was transmitted. A controller (e.g., controller 102) may collect the data received at the optical receiver in a depth histogram 880 wherein each bin (e.g., bin 884a-884n) corresponds to a different time window since the transmitted optical signal was transmitted.

For example, a first bin 884a of the depth histogram 880 may correspond to the light received at the optical receiver during the first bin time period after the optical pulse was transmitted; a second bin 884b of the depth histogram 880 may correspond to the light received at the optical receiver during the second bin time period after the optical pulse was transmitted; the third bin 884c of the depth histogram 880 may correspond to the light received at the optical receiver during the third bin time period after the optical pulse was transmitted; and so on.

Optical pulses are periodically transmitted and the returning optical signal accumulated in bins (e.g., bins 884a-884n) over an integration time period. For example, an integration time period may include hundreds or thousands of pulses and last for tens of milliseconds. During the integration time period, counts in each of the bins of the histogram are accumulated. The counts accumulated in the bin represent the amount of light received at the optical receiver during the time period corresponding to the bin. Thus, at the end of an integration period, data values in the histogram (e.g., peaks) exceeding the noise level may indicate one or more times at which reflections of the optical signal were received. Such data values in the histogram may be used to determine physical characteristics of target objects in an external environment.

As depicted in FIG. 8, one or more of the initial bins 884a-884e may accumulate detected returning optical signals due to crosstalk. Such crosstalk may be due to optical components of the optical ranging sensor, reflections off the convex reflective surface, reflections of the side walls of the housing, and/or reflections off other portions of the housing. In the modified depth histogram 882, the one or more initial bins 884a-884e, may be cleared and/or ignored during object detection. Thus, false detections due to components of the optical ranging sensor system and housing may be ignored. In such an embodiment, the optical ranging sensor system may be unable to detect target objects within a minimum detection distance. Adjusting the number of bins in the depth histogram 880 that are ignored may balance false detections due to crosstalk and the minimum detection distance. For example, reducing the number of bins 884a-884n that are ignored may reduce the minimum detection distance (and increase the detection range of the optical ranging sensor system), however, the optical ranging sensor system may be more susceptible to false detections due to crosstalk. Increasing the number of bins 884a-884n that are ignored may increase the minimum detection distance (and decrease the detection range of the optical ranging sensor system), however, the optical ranging sensor system may be less susceptible to false detections due to crosstalk.

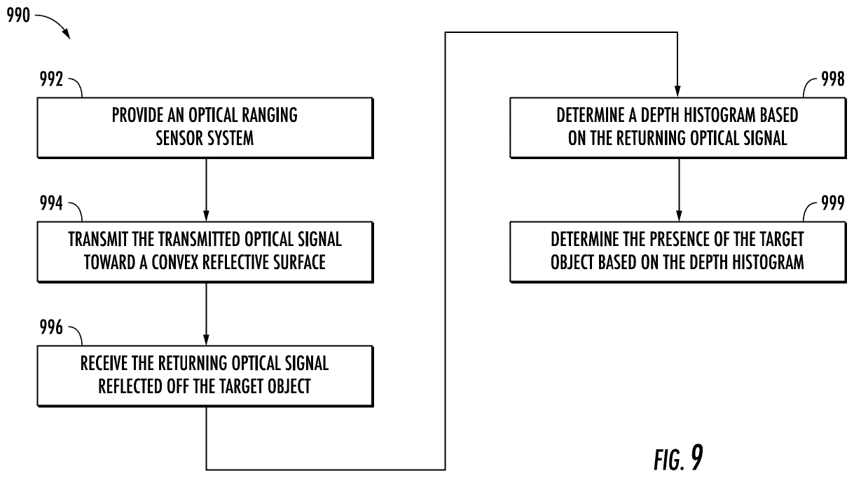

Referring now to FIG. 9, an example process 990 for detecting a presence of a target object (e.g., target object 104) is provided. At block 992, an optical ranging sensor system (e.g., optical ranging sensor system 230) is provided. The optical ranging sensor system comprises an optical transmitter (e.g., optical transmitter 108) having a transmission field-of-view (e.g., transmission field-of-view 444), configured to transmit a transmitted optical signal (e.g., transmitted optical signal 118); an optical receiver (e.g., optical receiver 110) having a return field-of-view (return field-of-view 446) and configured to receive a returning optical signal (e.g., returning optical signal 120) reflected off the target object; and a convex reflective surface (e.g., convex reflective surface 232) positioned within the transmission field-of-view and the return field-of-view. As described herein, the transmitted optical signal is reflected off the convex reflective surface toward the target object in a detection field-of-view (e.g., detection field-of-view 342).

At block 994, a controller (e.g., controller 102) transmits the transmitted optical signal toward the convex reflective surface. The controller may generate one or more control commands received at an optical ranging sensor coordinating the transmission of a transmitted optical signal with the reset of the optical receiver circuitry. The controller may further control the magnitude, duration, and modulation format of the transmitted optical signal. For example, in some embodiments, the controller may cause the transmission of one or more optical pulses. Further, in some embodiments, the controller may alter or reduce the optical pulse width to differentiate returning optical signals due to crosstalk from returning optical signals reflected off a target object.

At block 996, a controller receives the returning optical signal reflected off the target object. In some embodiments, the returning optical signal is captured by the optical receiver and converted to an electrical output. The electrical output may be used to determine the amount of light received at a location (e.g., pixel) on the optical receiver during a particular time period. For example, an accumulated charge at each pixel location of an optical receiver may be transmitted to the controller.

At block 998, a controller determines a depth histogram (e.g., depth histogram 880) based on the returning optical signal. A depth histogram may represent the light data received at the optical receiver in a depth histogram during a time window since the transmitted optical signal is transmitted. For example, each bin in the depth histogram may correspond to the light received at the optical receiver during the time period associated with the bin. The depth histogram may be utilized to determine presence, and/or motion characteristics of a target object. In some embodiments, one or more initial bins representing the closest distances to the optical ranging sensor system may be ignored to mitigate crosstalk reflected from one or more portions of the optical ranging sensor system.

At block 999, a controller determines the presence of the target object based on the depth histogram. The controller may determine histogram bins exceeding a minimum threshold, such as a noise level. Any bin of the depth histogram or modified depth histogram exceeding the noise level may indicate the presence of a target object. Because the transmitted optical signal is reflected off a convex reflective surface, the optical ranging sensor system may detect target objects in a 360-degree detection field-of-view. In a lateral direction from the optical ranging sensor system.

Referring now to FIG. 10, FIG. 10 illustrates an example controller 102 in accordance with at least some example embodiments of the present disclosure. The controller 102 includes processor 1002, input/output circuitry 1004, data storage media 1006, and communications circuitry 1008. In some embodiments, the controller 102 is configured, using one or more of the sets of circuitry 1002, 1004, 1006, and/or 1008, to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, two sets of circuitry may both leverage use of the same processor(s), network interface(s), storage medium(s), and/or the like, to perform their associated functions, such that duplicate hardware is not required for each set of circuitry. The user of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively, or additionally, in some embodiments, other elements of the controller 102 provide or supplement the functionality of other particular sets of circuitry. For example, the processor 1002 in some embodiments provides processing functionality to any of the sets of circuitry, the data storage media 1006 provides storage functionality to any of the sets of circuitry, the communications circuitry 1008 provides network interface functionality to any of the sets of circuitry, and/or the like.

In some embodiments, the processor 1002 (and/or co-processor or any other processing circuitry assisting or otherwise associated with the processor) is/are in communication with the data storage media 1006 via a bus for passing information among components of the controller 102. In some embodiments, for example, the data storage media 1006 is non-transitory and may include, for example, one or more volatile and/or non-volatile memories. In other words, for example, the data storage media 1006 in some embodiments includes or embodies an electronic storage device (e.g., a computer readable storage medium). In some embodiments, the data storage media 1006 is configured to store information, data, content, applications, instructions, or the like, for enabling the controller 102 to carry out various functions in accordance with example embodiments of the present disclosure.

The processor 1002 may be embodied in a number of different ways. For example, in some example embodiments, the processor 1002 includes one or more processing devices configured to perform independently. Additionally, or alternatively, in some embodiments, the processor 1002 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the controller 102, and/or one or more remote or “cloud” processor(s) external to the controller 102.

In an example embodiment, the processor 1002 is configured to execute instructions stored in the data storage media 1006 or otherwise accessible to the processor. Alternatively, or additionally, the processor 1002 in some embodiments is configured to execute hard-coded functionality. As such, whether configured by hardware or software methods, or by a combination thereof, the processor 1002 represents an entity (e.g., physically embodied in circuitry) capable of performing operations according to an embodiment of the present disclosure while configured accordingly. Alternatively, or additionally, as another example in some example embodiments, when the processor 1002 is embodied as an executor of software instructions, the instructions specifically configure the processor 1002 to perform the algorithms embodied in the specific operations described herein when such instructions are executed.

In some embodiments, the controller 102 includes input/output circuitry 1004 that provides output to the user and, in some embodiments, to receive an indication of a user input. In some embodiments, the input/output circuitry 1004 is in communication with the processor 1002 to provide such functionality. The input/output circuitry 1004 may comprise one or more user interface(s) (e.g., user interface) and in some embodiments includes a display that comprises the interface(s) rendered as a web user interface, an application user interface, a user device, a backend system, or the like. The processor 1002 and/or input/output circuitry 1004 comprising the processor may be configured to control one or more functions of one or more user interface elements through computer program instructions (e.g., software and/or firmware) stored on a memory accessible to the processor (e.g., data storage media 1006, and/or the like). In some embodiments, the input/output circuitry 1004 includes or utilizes a user-facing application to provide input/output functionality to a client device and/or other display associated with a user.

In some embodiments, the controller 102 includes communications circuitry 1008. The communications circuitry 1008 includes any means such as a device or circuitry embodied in either hardware or a combination of hardware and software that is configured to receive and/or transmit data from/to a network and/or any other device, circuitry, or module in communication with the controller 102. In this regard, the communications circuitry 1008 includes, for example in some embodiments, a network interface for enabling communications with a wired or wireless communications network. Additionally, or alternatively in some embodiments, the communications circuitry 1008 includes one or more network interface card(s), antenna(s), bus(es), switch(es), router(s), modem(s), and supporting hardware, firmware, and/or software, or any other device suitable for enabling communications via one or more communications network(s). Additionally, or alternatively, the communications circuitry 1008 includes circuitry for interacting with the antenna(s) and/or other hardware or software to cause transmission of signals via the antenna(s) or to handle receipt of signals received via the antenna(s). In some embodiments, the communications circuitry 1008 enables transmission to and/or receipt of data from a client device in communication with the controller 102.

Additionally, or alternatively, in some embodiments, one or more of the sets of circuitry 1002-1008 are combinable. Additionally, or alternatively, in some embodiments, one or more of the sets of circuitry perform some or all of the functionality described associated with another component. For example, in some embodiments, one or more sets of circuitry 1002-1008 are combined into a single module embodied in hardware, software, firmware, and/or a combination thereof. Similarly, in some embodiments, one or more of the sets of circuitry is/are combined such that the processor 1002 performs one or more of the operations described above with respect to each of these circuitry individually.

While this detailed description has set forth some embodiments of the present invention, the appended claims cover other embodiments of the present invention which differ from the described embodiments according to various modifications and improvements. For example, one skilled in the art may recognize that such principles may be applied to any electronic device that may benefit from detecting presence and/or motion of target objects proximate the electronic device. For example, robotic vacuums, robotic mops, robotic lawn mowers, smart speakers, virtual assistants, motion detect lights, motion detect cameras, household appliances, smart thermostats, and so on.

Within the appended claims, unless the specific term “means for” or “step for” is used within a given claim, it is not intended that the claim be interpreted under 35 U.S.C. 112, paragraph 6.

Use of broader terms such as “comprises,” “includes,” and “having” should be understood to provide support for narrower terms such as “consisting of,” “consisting essentially of,” and “comprised substantially of” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

1. An optical ranging sensor system comprising:
an optical transmitter having a transmission field-of-view, configured to transmit a transmitted optical signal;
an optical receiver having a return field-of-view and configured to receive a returning optical signal reflected off a target object; and
a convex reflective surface positioned within the transmission field-of-view and the return field-of-view;
wherein the transmitted optical signal is reflected off the convex reflective surface toward the target object in a detection field-of-view.

2. The optical ranging sensor system of claim 1, wherein the transmitted optical signal is transmitted along a transmission axis, and the detection field-of-view is perpendicular to the transmission axis.

3. The optical ranging sensor system of claim 1, wherein the convex reflective surface is stationary.

4. The optical ranging sensor system of claim 1, wherein the detection field-of-view is 360 degrees.

5. The optical ranging sensor system of claim 1, wherein the convex reflective surface is positioned at a minimum overlap distance from an intersection line, wherein the intersection line intersects the optical transmitter and the optical receiver.

6. The optical ranging sensor system of claim 5, wherein the minimum overlap distance is determined based on a separation distance between the optical transmitter and the optical receiver, the transmission field-of-view, and the return field-of-view.

7. The optical ranging sensor system of claim 6, wherein a top portion of the convex reflective surface is at the minimum overlap distance relative to the intersection line.

8. The optical ranging sensor system of claim 1, wherein the convex reflective surface is centered between the optical transmitter and the optical receiver.

9. The optical ranging sensor system of claim 1, further comprising a housing configured to fix a position of the convex reflective surface relative to the optical transmitter and the optical receiver.

10. The optical ranging sensor system of claim 9, the housing further comprising:
a sensor compartment defining a sensor cavity,
wherein the optical transmitter and the optical receiver are disposed within the sensor cavity;
a bottom portion,
wherein the convex reflective surface is attached to the bottom portion; and
a side wall attaching the bottom portion to the sensor compartment.

11. The optical ranging sensor system of claim 10, wherein a portion of the side wall is optically transparent, such that the transmitted optical signal passes through the side wall.

12. The optical ranging sensor system of claim 10, wherein the side wall is circular.

13. The optical ranging sensor system of claim 1, wherein the transmitted optical signal is pulsed for an optical pulse width, and wherein the optical pulse width is less than 0.6 nanoseconds.

14. The optical ranging sensor system of claim 1, further comprising a controller configured to:
transmit the transmitted optical signal toward the convex reflective surface;
receive the returning optical signal reflected off the target object;
determine a depth histogram based on the returning optical signal; and
determine a presence of the target object based on the depth histogram.

15. A method for detecting a presence of a target object, the method comprising:
providing an optical ranging sensor system, the optical ranging sensor system comprising:
an optical transmitter having a transmission field-of-view, configured to transmit a transmitted optical signal;
an optical receiver having a return field-of-view and configured to receive a returning optical signal reflected off the target object; and
a convex reflective surface positioned within the transmission field-of-view and the return field-of-view;
wherein the transmitted optical signal is reflected off the convex reflective surface toward the target object in a detection field-of-view;
transmitting the transmitted optical signal toward the convex reflective surface;
receiving the returning optical signal reflected off the target object;
determining a depth histogram based on the returning optical signal; and
determining the presence of the target object based on the depth histogram.

16. The method of claim 15, further comprising:
removing one or more bins of the depth histogram representing returning optical signal reflected within a minimum depth detection distance.

17. The method of claim 15, wherein the convex reflective surface is stationary.

18. The method of claim 15, wherein the detection field-of-view is 360 degrees.

19. The method of claim 15, wherein the convex reflective surface is positioned at a minimum overlap distance from an intersection line, wherein the intersection line intersects the optical transmitter and the optical receiver, and wherein the minimum overlap distance is determined based on a separation distance between the optical transmitter and the optical receiver, the transmission field-of-view and the return field-of-view.

20. The method of claim 15, wherein the convex reflective surface is centered between the optical transmitter and the optical receiver.
